(19) United States
(12) Patent Application Publication
(10) Pub. No.: US 2016/0255859 A1
(43) Pub. Date: Sep. 8, 2016

(54) METHOD AND APPARATUS FOR MONITORING THE DISPENSING OF A SOFT SERVE PRODUCT

(71) Applicant: Mark Salerno, Huntington, NY (US)

(72) Inventor: Mark Salerno, Huntington, NY (US)

(21) Appl. No.: 15/061,269

(22) Filed: Mar. 4, 2016

Related U.S. Application Data
(60) Provisional application No. 62/128,276, filed on Mar. 4, 2015.

(51) Int. Cl. A23G 9/22; G08B 5/36; A23G 9/28

(52) U.S. Cl. CPC A23G 9/228; A23G 9/281; G08B 5/36

(57) ABSTRACT

A device for monitoring the dispensing of a soft serve product from a soft serve product dispensing machine has a housing with an open pocket formed in its side wall so that the monitoring device may be mounted on a handle of the product dispensing machine. The device includes electronic circuitry, including an accelerometer, that senses the position of the handle of the product dispensing machine. When the handle is sensed to be in a product dispense position, a timing circuit within the device monitors the time during which a soft serve product is dispensed by the machine. Knowing the flow rate of soft serve product from the dispensing machine, the monitoring device will cause a light emitting diode to illuminate to signal the user of the device to re-position the handle of the product dispensing device in the non-dispensing position.

### CROSS-REFERENCE TO RELATED APPLICATIONS

This application is related to U.S. Provisional Patent Application Ser. No. 62/128,276, which was filed on Mar. 4, 2015, and is entitled “Method and Apparatus for Monitoring the Dispensing of a Soft Serve Product”, the disclosure of which is hereby incorporated by reference and on which priority is hereby claimed.

### BACKGROUND OF THE INVENTION

1. Field of Invention

This invention relates generally to devices that indicate to the user the amount of soft serve ice cream that is being dispensed from a soft serve machine during each serving.

2. Description of The Prior Art.

Soft serve ice cream machines are devices that are filled with a liquid food product. The liquid is passed over a cylindrical refrigerated surface. An auger scrapes the frozen product off the surface and extrudes the semi-frozen product out a dispensing port.

Operators hold the container under the dispensing port and move the frozen product around to produce a swirled finished product. The product is generally sold in several sizes, small, medium and large, in edible (ice cream cone) containers. The selling price is determined by the amount of product contained in each size.

Currently, operators use visual inspection to fill the edible containers with the prescribed amount of product for each size. After training, the operators will typically over-portion the product causing lower profit margin. There are no devices that attach to the soft serve product dispensing machines that help the user dispense the specified amount of soft serve product.

Therefore, it would be advantageous to provide a device that is attached to the dispensing handle of the machine and while the machine is dispensing product indicates to the user the amount of soft serve product that is being dispensed and indicates when the user should stop dispensing ice cream.

The soft serve product dispensing machines do not dispense at a constant flow rate. The rate of product flow changes based on the time between servings. When the machine is idle for a period of time, the product thaws and the flow rate is faster. If there is a short period of time between servings, the ice cream is thicker and the flow rate is slower. Therefore, it would be advantageous to provide a device that monitors the time between servings and compensates for the flow rate changes.

Soft serve product dispensing machines have handles that are pulled down to start the flow of product. In some model soft serve product dispensing machines, the handle “dispense-off ” position is in approximately a vertical position. In other model ice cream machines, the handle “dispense-off” position is approximately horizontal. If a soft serve product monitoring device is mounted on the handle, then the device user interface should be presented and visible to the user in an unobstructed fashion. For soft serve product dispensing machines that have the handle in the vertical position for the “dispense-off” position, a soft serve product dispensing monitoring device should be mounted under the handle so that, when the handle is pulled; the device user interface of the monitoring device is presented and visible to the user. When the handle is horizontal, the soft serve product dispensing monitoring device should preferably be mounted on the top of the handle so that when the handle is pulled, the user interface of the monitoring device is presented and visible to the user. Therefore, it would be advantageous to provide a soft serve product dispensing monitoring device which can be configured to be mounted on the top or bottom of the handle of the dispensing machine so that the user interface of the device is presented in an unobstructed way to the user.

When the handle of the dispensing machine is pulled, a soft serve product dispensing monitoring device attached to the handle needs to sense that the handle is now in the dispensing position or any position in between. Therefore, it would be advantageous to provide such a device with an accelerometer to detect the position of the handle.

The soft serve machine contains compressors to keep the fluid in a refrigerated state to prevent bacteria growth and spoiling. When the compressors turn on, the soft serve product dispensing machine and handle vibrate. Therefore, it would be advantageous to provide a soft serve product monitoring device that has mechanical and software filtering to prevent the device from turning on and detecting a false dispense.

When the soft serve product is flowing into the container, the user requires an indication that the flow has started and that the amount dispensed for a particular size has been achieved and, therefore, should stop dispensing product. Therefore, it would be advantageous to provide a user interface on a soft serve product monitoring device that shows that ice cream dispensing has started and indicates to the user when the amount of ice cream has been dispensed for a particular size.

The product flow rates of soft serve product dispensing machines can be mechanically adjusted. Some users prefer the flow rate to be fast to get better serve rates. Some users prefer the flow rate to be slower to get a better product presentation. Therefore, it would be advantageous to provide a way to calibrate the compensated flow rate for the different flow rates in a soft serve product monitoring device.

The dispense handles of many soft serve product dispensing machines are removable for cleaning. If a soft serve product monitoring device is mounted on the handle, powering the device with a wired external power source makes the removal from and re-mounting of the handle difficult. Therefore, it would be advantageous to provide a soft serve product monitoring device with components and algorithms that minimize power consumption of the device and that will allow the device to run on battery power for a maximum period of time.

### OBJECTS AND SUMMARY OF THE INVENTION

It is an object of the present invention to provide a device for monitoring the dispensing of a soft serve product and which includes a compensating algorithm that monitors the time between dispenses of the soft serve product and automatically adjusts when the “done” indicator lights.

It is another object of the present invention to provide a soft serve ice cream dispensing monitor which will allow the user to configure the monitor so that it may be mounted on a handle of an ice cream dispensing machine in a vertical disposition or a horizontal disposition.

It is yet another object of the present invention to provide a soft serve ice cream dispensing monitor which contains an accelerometer that monitors the position of a handle on a soft serve ice cream dispensing machine to detect that a user of the machine has started and stopped the dispensing of the soft serve ice cream.

It is a further object of the present of the invention to provide a soft serve ice cream dispensing monitor which includes an accelerometer and a filter for the accelerometer, which filters the accelerometer output signal to more accurately determine the position of the handle of a soft serve ice cream dispenser so as to alert the user not to start dispensing the soft serve ice cream when the compressor of the machine turns on.

It is an object of the present invention to provide an apparatus for monitoring the dispensing of a soft serve product, which apparatus includes a user interface that indicates to the user when the dispensing of a product has started and when the desired amount of the product has been dispensed.

It is yet another object of the present invention to provide a method of adjusting or calibrating flow compensating constants in a soft serve product dispensing monitor so that the monitor would match the flow rate of a particular soft serve product dispensing machine.

It is a further object of the present invention to provide a soft serve ice cream dispensing monitor that has low power-consuming components and includes algorithms which will minimize the power of the monitor such that the monitor may run on battery power for an extended period of time.

In accordance with the present invention a device that monitors the dispensing of soft serve ice cream mounts on the handle of a soft serve ice cream dispensing machine, and when the handle of the machine is pulled down, indicates to the user of the machine when the proper amount of soft serve ice cream has been dispensed by the machine.

These and other objects, features and advantages of the present invention will be apparent from the following detailed description of illustrative embodiments thereof, which is to be read in connection with the accompanying drawings.

### BRIEF DESCRIPTION OF DRAWINGS

FIG. 1 is a block diagram of a soft serve product monitor constructed in accordance with the present invention.

FIG. 2 is a schematic diagram of the electrical circuit of the soft serve product monitor of the present invention.

FIG. 3 is a flow chart illustrating the operation of the soft serve product monitor of the present invention in the reset firmware loop.

FIG. 4 is a flow chart illustrating the operation of the soft serve product monitor of the present invention in the wake and dispense firmware loop.

FIG. 5 is a flow chart illustrating the operation of the soft serve product monitor of the present invention in the firmware calibration mode.

FIG. 6 is a pictorial illustration of the user interface of the soft serve product monitor of the present invention.

FIGS. 7A and 7B are pictorial illustrations of the user interface of the soft serve product monitor of the present invention in an upright and an inverted disposition.

### DETAILED DESCRIPTION OF THE PREFERRED EMBODIMENTS

### Top Level Description of Method and Apparatus for the Soft Serve Display Device

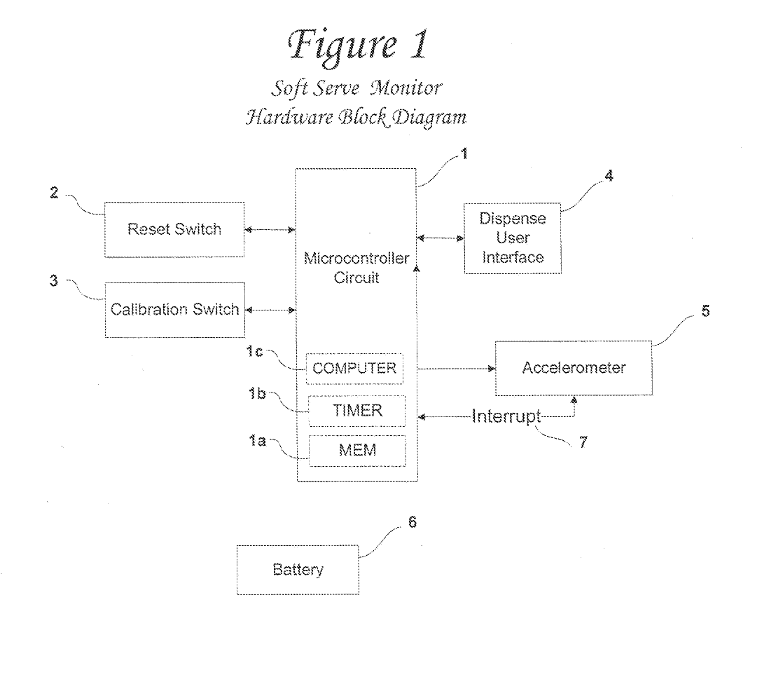

FIG. 1 shows the soft serve dispensing monitor hardware block diagram. The microcontroller circuit 1 contains a computer 1c, timer 1b and memory 1a and firmware stored in the memory that performs the following functions:

1—Reads the accelerometer 5 to determine the position of the handle of the soft serve product dispensing machine (the device of the present invention is preferably designed to be mounted on the handle);

2—Turns on and off the LEDs on the user interface 4 to show the amount of ice cream product dispensed;

3—Monitors the calibration switch 3 to perform a calibration function;

4—Contains in memory 1a the flow rate over time firmware tables to look up flow rate and calculate the amount of product dispensed;

5—Contains timers 1b to measure the time between dispenses to calculate dispense amounts;

6—Turns off the LEDs of the user interface 4 and controls the power down of the system to maximize the life of the battery 6; and

7—Monitors the interrupt line 7 of the accelerometer 5 while the device is in a “sleep” mode in order to minimize power consumption.

The battery 6 provides power to the device. When the reset switch 2 is pressed, the microcontroller 1 resets. The calibration switch 3 is used to place the device into a calibration mode in which the device will enter a calibration factor (“Cal Factor”) to change the flow rate table stored in memory 1a for the machine that the device is attached to.

### Top Level Summary of Operation

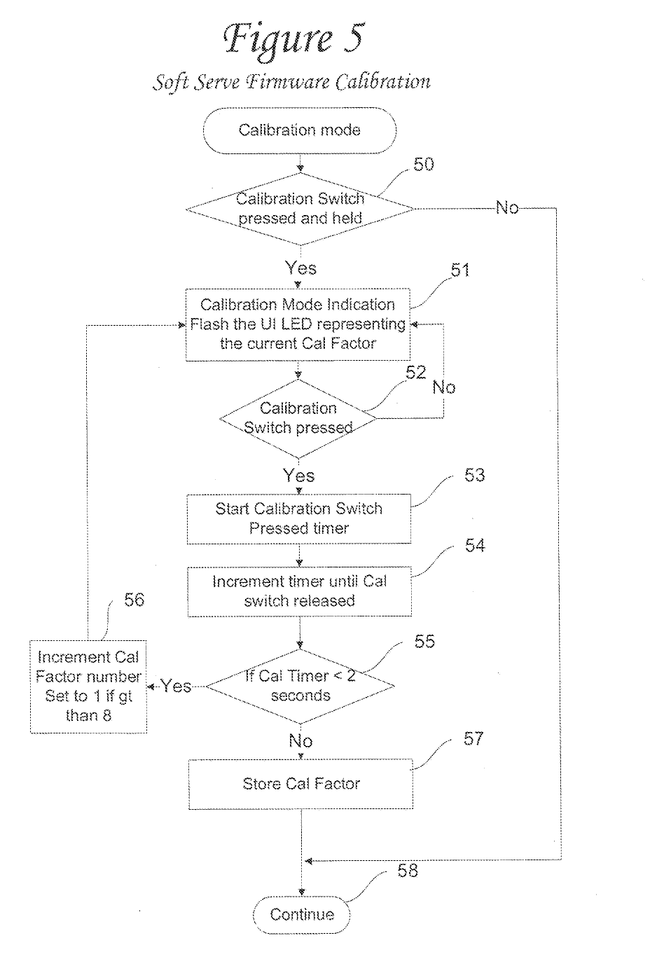

FIG. 6 shows the preferred user interface overlay 60 of the device mounted on an exposed side of the housing of the device which is visible to the user. The user mounts the device onto the ice cream machine dispensing handle 80 at the round edge 63. The handle 80 will be in the non-dispensing position at a 60 degree angle. After mounting and with the handle 80 in the non-dispensing position, the user presses the reset switch 2 on the rear side of the device housing, opposite the side having the user interface overlay 60. Referencing FIG. 1, this causes the microcontroller 1 to read the accelerometer 6 and save the home (non-dispensing) position of the handle to memory 1a.

When the user pulls on the handle 80, the left. LED indicator 61 (when viewing FIG. 6), which is preferably yellow, will light, indicating to the user that a dispense of product has started. As the ice cream is flowing into the product container (e.g., a cone or cup), the user observes the indicators moving left to right, showing the amount dispensed. When the green indicator 62 of the desired size (S=small; M=medium; L=large; and XL=extra large) is reached, the user moves the handle 80 back to the non-dispensing position. After a few seconds, the device goes into a power save mode by turning off all of the LEDs and powering down the circuit of the device to a sleep mode.

### Detailed Description of the Apparatus for the Soft Serve Display

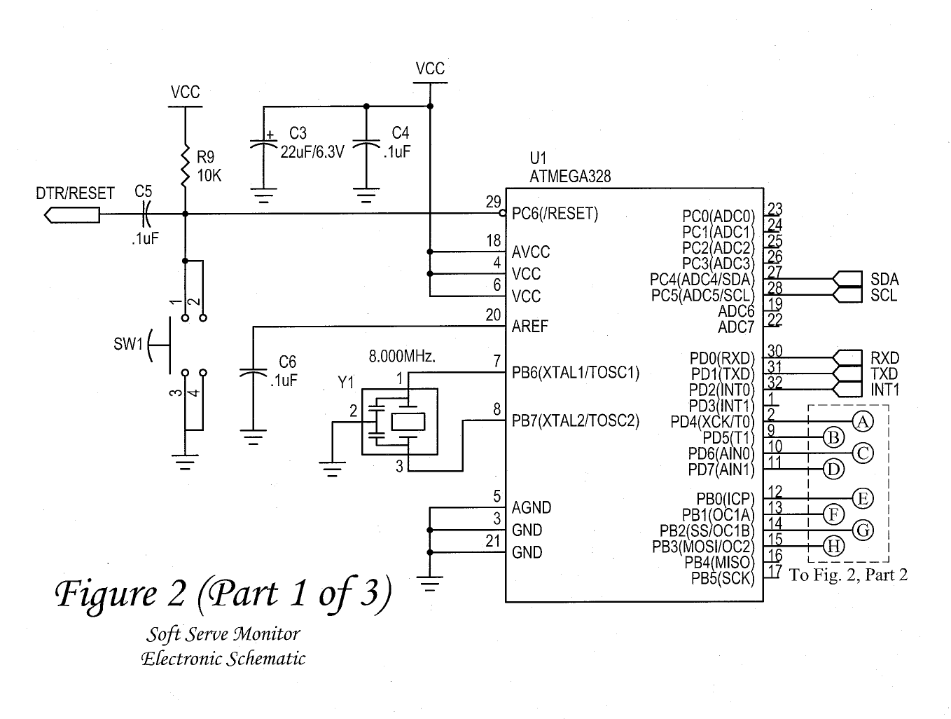

FIG. 2 shows the electrical circuit schematic of the soft serve product monitor of the present invention. U1 is a microcontroller that in the preferred embodiment allows low power operation and even lower power sleep modes, direct drive of the LEDs, an I2C communication bus for communication with the accelerometer, program flash memory for storing programs, an EE PROM memory for storing calibration values and a RAM memory for storing temporary variables.

The accelerometer U2 measures and reports the amount of gravity that is pulling on the device in the x-y, y-z or x-z planes. The accelerometer is mounted on a printed circuit board that is disposed in parallel with the front face of the user interface. The soft serve product monitoring device is mounted to the handle 80 of the soft serve product dispensing machine. When the accelerometer is moved to a different position, the changes in gravity sensed by the accelerometer on the x, y or z axis, or multiple axes, are signaled to the microcontroller U1.

After the user mounts the soft serve monitoring device on the handle 80 of the dispensing machine and presses the reset switch SW1, the microcontroller U1 resets. Initialization commands are sent to the accelerometer U2 by the microcontroller U1. These commands set the sensitivity, frequency of measurement and interrupt generation movement sensitivity. The accelerometer U2 will generate an interrupt and signal the microcontroller to wake up because dispensing has started.

When the microcontroller U1 is idle for a period of time, the microcontroller goes into the sleep mode to conserve power.

When the microcontroller U1 receives an interrupt signal from the accelerometer U2, the microcontroller U1 turns on the first yellow LED light, indicating the device is in the dispensing mode. The microcontroller U1 starts a dispense timer. The microcontroller calculates the ounces dispensed using the formula:

FLOW RATE LOOK UP oz/ms*TIME DISPENSED ms=OUNCES DISPENSED

The microcontroller U1 compares the OUNCES DISPENSED to the LED-to-ounces table stored in memory and turns on the appropriate LED indicator LD1 through LD8 that shows the user how much product has been dispensed.

The FLOW RATE LOOK UP is a table stored in memory that is generated by direct measurements of a typical soft serve product dispensing machine. The flow rate in oz/ms goes down when the time between dispenses is small and goes up when the time between dispenses is large.

When the dispense of product is complete, the microcontroller U1 starts a “time between dispense” timer and then enters a sleep mode. When the microcontroller U1 wakes again, the time between dispense is captured and used during dispense to look up the current flow rate from the FLOW RATE table.

Y1 is the crystal oscillator that is used by the microcontroller U1 to generate the master clock. J1 is a connector that is used to reprogram the microcontroller U1.

### Detailed Description of the Firmware Block Diagram

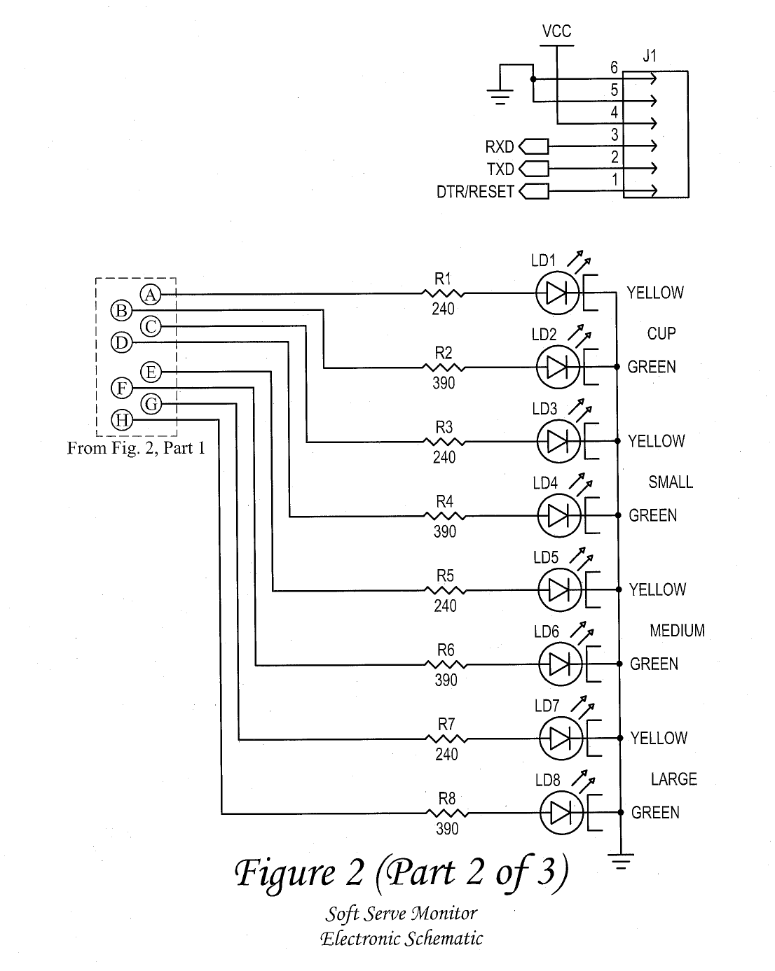

FIGS. 3, 4 and 5 show the firmware block diagrams for the monitor of the present invention. FIG. 3 shows the “reset firmware loop” block diagram. The reset function (Block 30) is performed when the reset switch 2 is pressed. The system then performs an initialization of variables as shown in Block 31, which is performed by the microcontroller 1 storing the variables in memory 1a. The accelerometer's position is read at Block 32, and the reading is saved as the off position as shown in Block 33. The system then performs an LED test (Block 34) by sequencing each LED from left to right. The system then performs a sleep function by shutting down the microcontroller (Block 35).

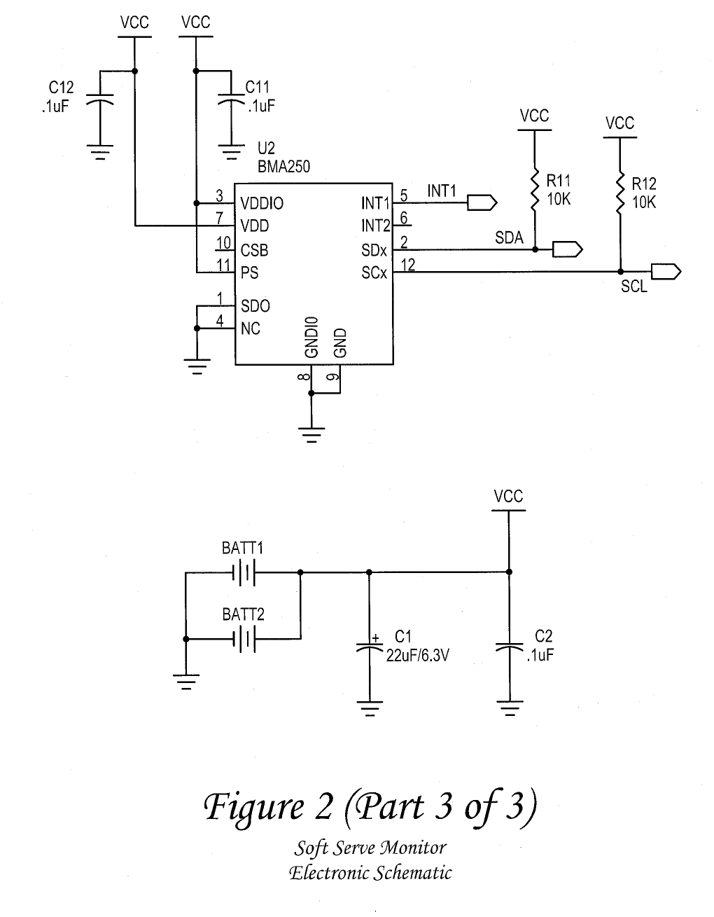

FIG. 4 shows the “wake and dispense” firmware loop. Block 40 shows the start of the “wake” process. When the accelerometer 5 detects movement, the accelerometer generates an interrupt signal. This signal causes the microcontroller 1 to wake and begin processing. Block 41 shows the microcontroller reading signals from the accelerometer. At Block 42, a comparison is made to check if the handle 80 of the product dispensing machine is in the dispense position. Block 43 recalls the time between dispenses which is used to compensate for flow rate. At Block 44, a dispense timer is started. At Block 45, the total dispense is calculated by the formula:

FLOW RATE LOOK UP oz/ms*TIME DISPENSED ms=OUNCES DISPENSED

At Block 46, select LEDs are lit based on the ounces dispensed, as shown, for example in the table below:
0-3 ounces Yellow Cup/Cone LED
3-4.3 ounces Green Cup/Cone LED
   The ounces and sizes can be customized for various end users.

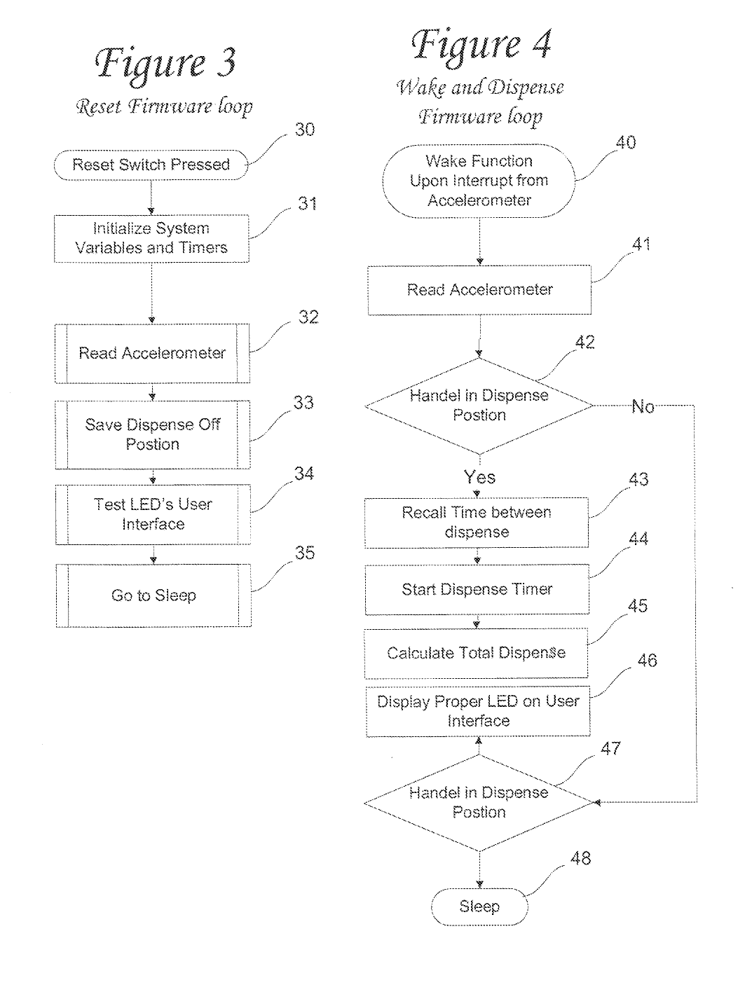

FIG. 5 shows the firmware block diagram of the calibration mode. The calibration mode is entered by pressing and holding calibration switch 3 (Block 50). When the switch is released, the user interface shows one LED flashing, indicating the unit is in calibration during which the “Cal Factor” is set (Block 51). When the calibration switch 3 is pressed, at Block 52, a timer is started at Block 53. The timer is incremented at Block 54, and when the switch is released, the timer is compared at Block 55. If the switch was held for less then two seconds, the “Cal Factor” is incremented at Block 56 and operational flow is looped back to Block 51. At Block 56, if the “Cal Factor” number goes above 8, for example, it is reset to 1.

At Block 55, if the calibration switch 3 is held for two or more seconds, then the “Cal Factor” is stored in memory (Block 57), and the device ends the calibration mode routine (Block 58).

### Detailed Description of the Dual Mounting User Interface

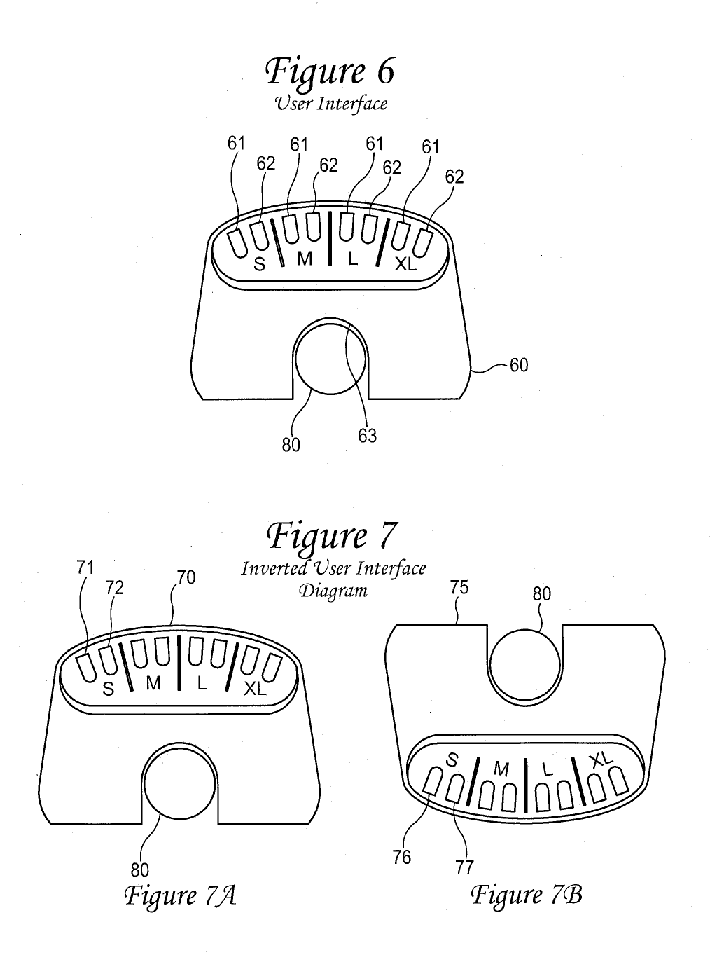

FIG. 7A shows the user interface mounted on the top of the handle 80 in an upright disposition 70 and FIG. 7B shows the interface mounted in an inverted disposition 75 on the bottom of the handle 80. In order to accommodate the two mounting options (70, 75), it is shown in FIGS. 7A and 7B how the same components and firmware are used to create the two mounting options. In a top mounting option 70, the yellow LEDs are placed in the light gray positions shown in FIG. 7A, starting with LED 71. The green LEDs are placed in the black LED positions shown in FIG. 7A, starting at LED 72.

In the bottom or inverted mounting option 75 shown in FIG. 7B, the LEDs are placed in reverse order. The yellow LEDs are placed in the light gray positions shown in FIG. 7B, starting at LED 76. The green LEDs shown in FIG. 7B, are placed in the black LED positions shown in FIG. 7B, starting at LED 77.

During reset, the accelerometer detects the home mounting position and reverses the operation of the LEDs for all functions.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A device for monitoring the dispensing of a soft serve product from a soft serve product dispensing machine, the product dispensing machine having a handle that is graspable by a user and angularly movable between at least a first angular position, in which no soft serve product is dispensed from the product dispensing machine, and a second angular position, in which soft serve product is dispensed from the product dispensing machine, the monitoring device comprising:
a housing, the housing being mountable on the handle of the soft serve product dispensing machine, the housing defining an internal cavity, the housing further having an exterior wall;
electronic circuitry situated within the internal cavity or mounted on the housing of the monitoring device, the electronic circuitry including:
a handle position sensor, the handle position sensor sensing the position of the handle of the soft serve product dispensing machine, the handle position sensor generating an output signal indicative of the sensed position of the handle;
a microcontroller, the microcontroller being responsive to the output signal of the handle position sensor;
a time-between-dispenses timing circuit, the time-between-dispenses timing circuit forming part of or being operatively coupled to the microcontroller circuit and determining the time period between a first time and a second time, the first time being the time when the handle of the product dispensing machine returns to the first angular, non-dispensing position from the second angular, dispensing position, the second time being the time the handle is next moved after the first time from the first angular, non-dispensing position to the second angular, dispensing position, thereby determining a time interval between successive product dispenses, the time-between-dispenses timing circuit generating an output signal indicative of the time interval between successive product dispenses;
a dispense timing circuit, the dispense timing circuit forming part of or being operatively coupled to the microcontroller circuit, the dispense timing circuit monitoring the time period during which the handle of the product dispensing machine is not in the first angular, non-dispensing position;
a memory circuit, the memory circuit forming part of or being operatively coupled to the microcontroller circuit, the memory circuit storing therein values corresponding to the dispense flow rate of soft serve product dispensed by the product dispensing machine; and
a user interface, the user interface being situated in or on the housing, the user interface including a plurality of light emitting devices mounted on the exterior wall of the housing so as to be visible to a user of the monitoring device, the light emitting devices being operatively coupled to the microcontroller circuit such that the illumination and non-illumination of the light emitting devices is selectively controlled by the microcontroller circuit, the plurality of light emitting devices including at least a first light emitting device and a second light emitting device;
wherein the microcontroller circuit, in response to the output signal from the handle position sensor, causes the first light emitting device to illuminate when the handle of the product dispensing machine is moved from the first angular, non-dispensing position toward the second angular, dispensing position; and
wherein the microcontroller circuit, in response to the dispense flow rate values stored in the memory circuit and the output signal of the time-between-dispenses timing circuit indicative of the time interval between successive product dispenses, causes the second light emitting device to illuminate when a select quantity of soft serve product is determined to have been dispensed by the product dispensing machine, the illumination of the second light emitting device indicating to the user of the monitoring device to re-position the handle of the product dispensing machine to the first angular, non-dispensing position.

2. A device for monitoring the dispensing of a soft serve product as defined by claim 1, wherein the handle position sensor includes an accelerometer.

3. A device for monitoring the dispensing of a soft serve product as defined by claim 1, wherein the housing includes an opening formed through the thickness thereof, the opening being dimensioned to receive therethrough the handle of the product dispensing machine so as to mount the monitoring device on the handle of the product dispensing machine.

4. A device for monitoring the dispensing of a soft serve product as defined by claim 1, wherein the housing further includes a side wall, the side wall having a U-shaped open pocket formed therein, the pocket being dimensioned to receive the handle of the product dispensing machine so as to mount the monitoring device on the handle of the product dispensing machine.

5. A device for monitoring the dispensing of a soft serve product as defined by claim 4, wherein the monitoring device is positionable in at least two different angular positions on the handle of the product dispensing machine when the monitoring device is mounted on the handle through the open pocket formed in the side wall of the housing.

6. A device for monitoring the dispensing of a soft serve product as defined by claim 1, wherein the value corresponding to the dispense flow rate of soft serve product dispensed by the product dispensing machine and stored in the memory circuit is a variable and is changeable by the microcontroller circuit based on the output signal of the time-between-dispenses timing circuit.

7. A device for monitoring the dispensing of a soft serve product as defined by claim 1, wherein the first light emitting device emits light of a first color and the second light emitting device emits light of a second color, the first color being different from the second color.

8. A device for monitoring the dispensing of a soft serve product as defined by claim 7, wherein the first light emitting device emits a yellow light, and the second light emitting device emits a green light.

9. A device for monitoring the dispensing of a soft serve product as defined by claim 1, wherein the user interface further includes a calibration switch, the calibration switch being mounted on the housing of the monitoring device, the calibration switch being activatable by a user of the monitoring device and, when activated by the user, generates a calibration signal provided to the microcontroller circuit; and
wherein the microcontroller circuit, in response to the calibration signal from the calibration switch, causes the monitoring device to enter into a calibration mode.

10. A device for monitoring the dispensing of a soft serve product as defined by claim 9, wherein a flow rate table is stored in the memory circuit, the flow rate table containing a plurality of flow rates generated by measurements of different soft serve product dispensing machines;
wherein, when the monitoring device enters the calibration mode, a light emitting device of the user interface illuminates to indicate to the user of the monitoring device that the monitoring device has entered the calibration mode; and
wherein, when the monitoring device is in the calibration mode, the user of the monitoring device may select a particular flow rate from the flow rate table stored in the memory circuit, whereby the microcontroller circuit changes the value of the dispense flow rate stored in the memory circuit and used to determine when the microcontroller circuit should cause the second light emitting device to illuminate to indicate to the user of the monitoring device to re-position the handle of the product dispensing machine to the first angular, non-dispensing position.

11. Apparatus for monitoring the dispensing of frozen food product, the frozen food product being dispensed from a dispensing machine having a handle actuator that is selectively adjustable by a user between at least a first position and a second position, wherein, when the handle is in the first position a dispensing cycle is initiated and frozen product is dispensed from a dispensing port in fluid communication with the machine, and when the handle is in the second position, the dispensing cycle is terminated and frozen product is not dispensed from the machine, the apparatus comprising:
at least one control unit, the at least one control unit having a microcontroller and at least one display operatively coupled to the microcontroller;
at least one handle position sensor, the at least one handle position sensor generating handle position signals indicative of the position of the handle actuator, the at least one handle position sensor being operatively coupled to the microcontroller, the microcontroller receiving the handle position signals therefrom;
at least one timer, the at least one timer generating at least a first timing signal and a second timing signal, the first timing signal being indicative of the duration of the dispensing cycle, the second timing signal being indicative of the duration of time between dispensing cycles, the at least one timer being operatively coupled to the microcontroller, the microcontroller receiving the first and second timing signals therefrom;
wherein the microcontroller generates at least a first dispensing cycle signal indicative of when the dispensing cycle is initiated and generates at least a second dispensing cycle signal when the microcontroller determines, at least partially in response to the first and second timing signals generated by the timer, when a select amount of frozen food product has been dispensed from the machine, the display receiving the first and second dispensing cycle signals and displaying visible indications corresponding thereto.

12. Apparatus for monitoring the dispensing of frozen food product as defined by claim 11, which further comprises:
a housing defining an internal cavity, the at least one control unit and at least one timer being at least partially enclosed by the housing and being at least partially received by the internal cavity thereof, the housing being mountable on the handle actuator of the dispensing machine.

13. Apparatus for monitoring the dispensing of frozen food product as defined by claim 11, wherein:
the at least one position sensor is an accelerometer.

14. Apparatus for monitoring the dispensing of frozen food product as defined by claim 11, wherein the display includes a plurality of light emitting diodes (LEDs), the LEDs being sequentially arranged and illuminable to indicate the quantity of frozen product dispensed.

15. Apparatus for monitoring the dispensing of frozen food product as defined by claim 11, wherein the control unit further includes at least one reset switch, the reset switch being operatively coupled to the microcontroller.

16. A method for monitoring the dispensing of a soft serve product from a soft serve product dispensing machine, the product dispensing machine having a handle that is graspable by a user and angularly movable between at least a first angular position, in which no soft serve product is dispensed from the product dispensing machine, and a second angular position, in which soft serve product is dispensed from the product dispensing machine, the monitoring method comprising the steps of:
mounting a soft serve product monitoring device on the handle of the soft serve product dispensing machine, the monitoring device having a housing defining an internal cavity, the housing further having an exterior wall, the monitoring device further having electronic circuitry situated within the internal cavity or mounted on the housing of the monitoring device, the electronic circuitry including:
a handle position sensor, the handle position sensor sensing the position of the handle of the soft serve product dispensing machine, the handle position sensor generating an output signal indicative of the sensed position of the handle;
a microcontroller, the microcontroller being responsive to the output signal of the handle position sensor;
a time-between-dispenses timing circuit, the time-between-dispenses timing circuit forming part of or being operatively coupled to the microcontroller circuit and determining the time period between a first time and a second time, the first time being the time when the handle of the product dispensing machine returns to the first angular, non-dispensing position from the second angular, dispensing position, the second time being the time the handle is next moved after the first time from the first angular, non-dispensing position to the second angular, dispensing position, thereby determining a time interval between successive product dispenses, the time-between-dispenses timing circuit generating an output signal indicative of the time interval between successive product dispenses;
a dispense timing circuit, the dispense timing circuit forming part of or being operatively coupled to the microcontroller circuit, the dispense timing circuit monitoring the time period during which the handle of the product dispensing machine is not in the first angular, non-dispensing position;
a memory circuit, the memory circuit forming part of or being operatively coupled to the microcontroller circuit, the memory circuit storing therein values corresponding to the dispense flow rate of soft serve product dispensed by the product dispensing machine; and
a user interface, the user interface being situated in or on the housing, the user interface including a plurality of light emitting devices mounted on the exterior wall of the housing so as to be visible to a user of the monitoring device, the light emitting devices being operatively coupled to the microcontroller circuit such that the illumination and non-illumination of the light emitting devices is selectively controlled by the microcontroller circuit, the plurality of light emitting devices including at least a first light emitting device and a second light emitting device;
sensing the position of the handle of the soft serve product dispensing machine;
determining the time period between the first time and the second time;
monitoring the time period during which the handle of the product dispensing machine is not in the first angular, non-dispensing position;
causing, by the microcontroller circuit of the monitoring device, in response to the output signal from the handle position sensor, the first light emitting device to illuminate when the handle of the product dispensing machine is moved from the first angular, non-dispensing position toward the second angular, dispensing position; and
causing, by the microcontroller circuit of the monitoring device, in response to the dispense flow rate values stored in the memory circuit and the output signal of the time-between-dispenses timing circuit indicative of the time interval between successive product dispenses, the second light emitting device to illuminate when a select quantity of soft serve product is determined to have been dispensed by the product dispensing machine, the illumination of the second light emitting device indicating to the user of the monitoring device to re-position the handle of the product dispensing machine to the first angular, non-dispensing position.

17. A method for monitoring the dispensing of a soft serve product as defined by claim 16, further comprising the step of:
changing, by the microcontroller circuit of the monitoring device, the value corresponding to the dispense flow rate of soft serve product dispensed by the product dispensing machine and stored in the memory circuit based on the output signal of the time-between-dispenses timing circuit, the value being a variable.

18. A method for monitoring the dispensing of a soft serve product as defined by claim 16, further comprising the step of:
storing in the memory circuit of the monitoring device a flow rate table, the flow rate table containing a plurality of flow rates generated by measurements of different soft serve product dispensing machines.

19. A method for monitoring the dispensing of a soft serve product as defined by claim 18, further comprising the step of:
changing, by the microcontroller circuit of the monitoring device, the value of the dispense flow rate stored in the memory circuit and used to determine when the microcontroller circuit should cause the second light emitting device to illuminate to indicate to the user of the monitoring device to re-position the handle of the product dispensing machine to the first angular, non-dispensing position, in response to the user of the monitoring device selecting a particular flow rate from the flow rate table stored in the memory circuit.

20. A method for monitoring the dispensing of a soft serve product as defined by claim 16, wherein the monitoring device includes an accelerometer, the accelerometer being used to sense the position of the handle of the soft serve product dispensing machine.
